(19) United States
(12) Patent Application Publication
(10) Pub. No.: US 2006/0109646 A1
(43) Pub. Date: May 25, 2006

(54) Forearm-mounted task light

(76) Inventor: Jeffrey C. Bruno, Barnegat Light, NJ (US)

Correspondence Address: Charles I. Brodsky, 2 Bucks Lane, Marlboro, NJ, 07746, US

(21) Appl. No.: 10/995,772

(22) Filed: Nov. 24, 2004

(51) Int. Cl. F21V 21/08

(52) U.S. Cl. 362/103

(57) ABSTRACT

A light-emitting diode illumination device secured to a user's forearm producing illumination in the area where it is desired, including a directable lighthead, a battery pack and an adjustable harness to secure the device to the user's forearm just below the elbow, with the lighthead being worn at the anterior radial-ulnar region.

### CROSS-REFERENCE TO RELATED APPLICATIONS

A provisional application describing this invention was filed March ______, 2004 and assigned Ser. No. 60/______.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not applicable.

### BACKGROUND OF THE INVENTION

1. Field of the Invention

This invention relates to flashlights, in general, and to an improved way of utilizing flashlights for hands-free illumination, in particular.

2. Description of the Related Art

The use of flashlights secured to one's clothing, or to one's wrist, are known in the art. Those secured to clothing, however, oftentimes are positioned too far from a user's hands to give acceptable illumination—or are overly bulky and cumbersome in use. Those which are wrist mounted frequently do not allow for easy movement of the user's hands, or are impaired in operation by clothing bunching up and blocking the illumination provided.

Helmet lights are often worn in fire fighting, epaulet mounted flashlights are frequently employed by police, and wrist mounted lights are many times used by emergency medical technicians and “first-responders” at highway accident scenes. Problems with these and allied uses of flashlights include the bumping of the helmet light accidentally and the need to train the head for proper positioning of the light, the heaviness of the clothing secured flashlights by virtue of the large D-size batteries employed, and the interference with the illumination provided by the movement of the fingers and hands with the wrist mounted flashlights.

### SUMMARY OF THE INVENTION

As will become apparent, a forearm-worn flashlight according to the invention obviates these problems, and allows enhanced illumination over the wrist mounted light due to the increased distance the flashlight is worn from the illuminated area.

The forearm-mounted illumination device of the invention will be seen to comprise four primary components—a lighthead, a power pack, a wire to join them together electrically, and a strap. In simplest terms, the strap positions the lighthead on the upper anterior radial-ulnar region of the forearm. The muscle mass there, which constitutes the widest part of the forearm, is useful in positioning the lighthead away from the plane of the wrist and hand. This acts to allow the illumination to be less obscured by the hand, or by any clothing worn. Positioning the lighthead in this way, as well as on the upper region of the inner forearm, allows illumination to develop and “flood” the subject of the illumination.

More specifically, the forearm mounted illumination device constructed according to the invention includes a strap of a length which encircles the upper portion of a user's forearm when worn. A lighthead including a plurality of light emitting diodes is secured to the strap at a first location, while an electrical battery pack for the light emitting diodes is secured to the strap at a second location. An insulated wire coupling is employed from the battery pack to the lighthead so as to energize the light emitting diodes as desired, with the lighthead being positioned on the strap to lie inside of the forearm when worn, at the upper anterior radial-ulnar region. In such configuration, the battery pack is positioned to lie substantially outside of the forearm, at the posterior radial-ulnar region.

In a preferred embodiment of the invention, the light emitting diodes are aligned in a row along the inside of the forearm so as to illuminate an area adjacent to a user's fingers. To optimize the illumination, the lighthead includes a pivotable base housing the light emitting diodes, and hinged to rotate substantially 180°. With the strap being adjustable in length—as by an included hook-and-loop adhesive—, the strap is of a length to encircle the upper portion of a user's forearm just below the elbow. The battery pack in such an arrangement may include the needed electrical drive circuitry for the light emitting diodes along with an electrical switch to control the illumination afforded. Such electrical switch may provide an ON-OFF function for the forearm mounted flashlight, especially one which employs five light emitting diodes. Where such diodes are each of 10,000 millicandela intensity, the battery pack could include three AA batteries for the required energization. The lighthead and forearm mounted device in such manner will be seen to be very compact, and effectively unobtrusive to a wearer.

### BRIEF DESCRIPTION OF THE DRAWINGS

These and other features of the present invention will be more clearly understood from a consideration of the following description taken in connection with the accompanying Drawings in which:

FIG. 1 is a cutaway-plan view of the forearm-mounted task light of the invention;

FIG. 2 is side elevational view of the forearm-mounted light of FIG. 1; and

FIG. 3 is a cutaway frontal elevational view of the forearm-mounted light.

### DETAILED DESCRIPTION OF THE INVENTION

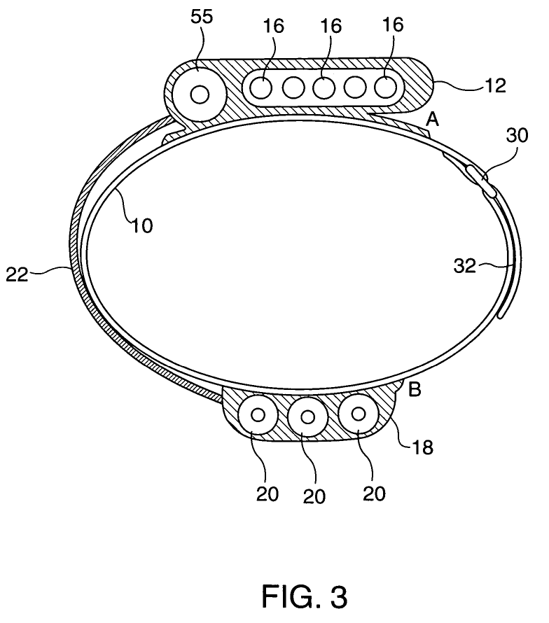

In the Drawings, the forearm-mounted illumination device includes a strap 10 of a length which encircles the upper portion of a user's forearm when worn. A lighthead 12 includes a pivotable base 14 housing a plurality of light emitting diodes 16 secured to the strap 10 at a first location A. An electrical battery pack for the light emitting diodes 16 is shown at 18, secured to the strap 10 at a second location B. (For the preferred embodiment of the Drawings, three AA batteries 20 are housed within the pack 18 to power five light emitting diodes 16.) To energize the light emitting diodes 16, an insulated wire coupling 22 is shown extending from the battery pack 18 to the lighthead 12. The pivotal base shown at 14 is rotatable by means of a hinge 24 in well understood manner. In accordance with the invention, the lighthead 12 is positioned at A on the strap 10 so as to lie inside the forearm of the user, at the anterior radial-ulnar region. The positioning of the battery pack 18 at B on the strap 10 is to lie substantially outside the forearm, at the posterior radial-ulnar region. As more clearly shown in FIG. 3, the strap 10 is selected of a length to pass through a loop 30, and to be held in place by conventional Velcro hook-and-loop adhesive at 32 in encircling the upper portion of the user's forearm just below the elbow.

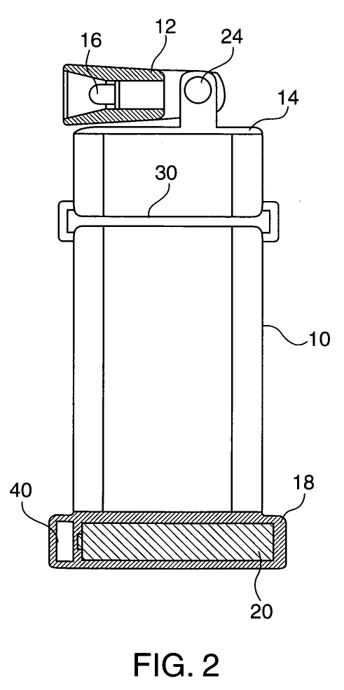

FIG. 3 illustrates the light emitting diodes 16 being aligned in a row when positioned along the inside of the forearm so as to illuminate the area adjacent a user's fingers. With the base 14 being pivotable, the lighthead thus is able to be rotated substantially 180° in affording a sweep to best illuminate the area being worked—whether it be medically by an emergency medical technician at an accident scene, or merely by a watch repairman or similar such mechanic. Reference numeral 40 in FIG. 2 identifies the electric drive circuitry for the light emitting diodes 16 as being housed in the battery pack 18, along with an electrical switch for controlling the illumination afforded by the forearm-mounted illumination device. Such switch could simply be of the “ON-OFF” variety, or could be a variable control to adjust the intensity of the illumination produced.

In securing the forearm-mounted illumination device to the upper-anterior portion of the forearm, the illumination developed becomes better distributable over a greater area than with a wrist mounted flashlight due to its increased distance from the illuminated area—while the use of light emitting devices allows the device to have an extremely tight profile. The hugging of the arm which results allows the user to slip the arm more easily into very tight spaces, and prevents the device from snagging or bumping—even to the extent of enabling it to be worn inconspicuously under one's clothing. The separation of the battery pack 18 on the posterior side of the forearm, separate from the lighthead on the anterior side, further gives the user a significantly improved level of comfort and an increased range of motion. Using light emitting diodes additionally gives the device an increased duration of usable light as compared with incandescent bulbs, together with a very high efficiency rating. Because no parabolic reflector is required, the forearm-mounted illumination device also is that much lighter in weight and less bulky in use. In this respect, the strap 10, the loop 30 and the Velcro-type adhesive together form an adjustable harness able to secure the forearm-mounted device just below the user's elbow when worn.

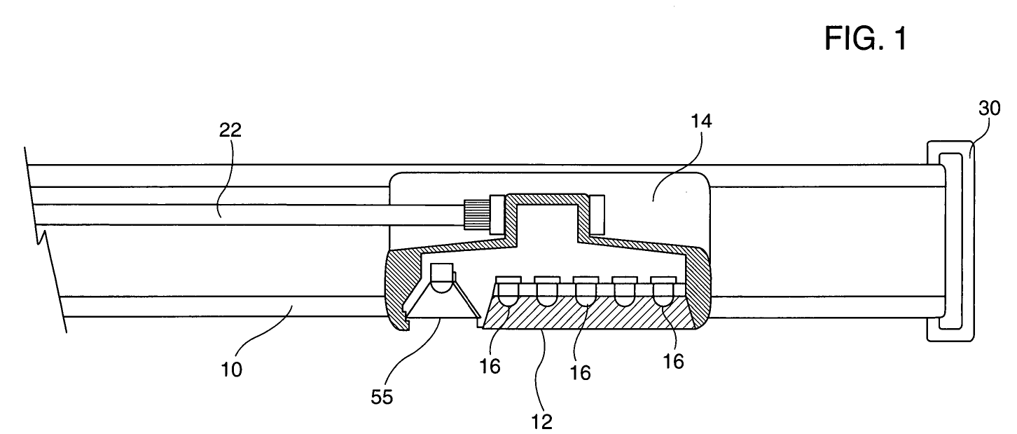

While there have been described what are considered to be preferred embodiments of the present invention, it will be readily appreciated by those skilled in the art that modifications can be made without departing from the scope of the teachings herein. Thus, although detracting somewhat from the benefits and advantages of the present invention, were a user desirous of also illuminating the area being worked upon with an incandescent bulb, one could be installed in the pivotable base 14 and wired to be energized with or aside from the light emitting diodes 16—by the same batteries 20 in the backpack 18, or by a separate battery supply. Such incandescent bulb is shown at 55 in FIGS. 1 and 3. For at least such reason, therefore, resort should be had to the claims appended hereto for a true understanding of the scope of the invention.

I claim:

1. A forearm-mounted illumination device comprising:
a strap of a length which encircles the upper portion of a user's forearm when worn;
a lighthead including a plurality of light emitting diodes secured to said strap at a first location thereon;
an electrical battery pack for said light emitting diodes secured to said strap at a second location; and
an insulated wire coupling said battery pack to said lighthead for energizing said light emitting diodes as desired;
with said lighthead being positioned on said strap to lie inside of the forearm when worn at the anterior radial-ulnar region thereof, with said battery pack being positioned to lie substantially outside of the forearm at the posterior radial-ulnar region.

2. The forearm-mounted device of claim 1 wherein said light emitting diodes are aligned in a row in said lighthead along the inside of the forearm in illuminating an area adjacent a user's fingers.

3. The forearm-mounted device of claim 2 wherein said lighthead includes a pivotable base housing said light emitting diodes.

4. The forearm-mounted device of claim 1 wherein said lighthead includes a pivotable base housing said light emitting diodes, and hinged to rotate substantially 180°.

5. The forearm-mounted device of claim 1 wherein said strap is adjustable in length.

6. The forearm-mounted device of claim 1 wherein said strap is adjustable in length by an included hook-and-loop adhesive.

7. The forearm-mounted device 1 of claim 1 wherein said battery pack includes electrical drive circuitry for said light emitting diodes and an electrical switch for controlling the illumination produced thereby.

8. The forearm-mounted device of claim 7 wherein said switch is an electrical ON-OFF switch.

9. The forearm-mounted device of claim 1 wherein said lighthead includes five light emitting diodes.

10. The forearm-mounted device of claim 1 wherein said lighthead includes five 10,000 millicandela light emitting diodes.

11. The forearm-mounted device of claim 10 wherein said electrical battery pack includes three AA batteries for energizing said light emitting diodes.

12. The forearm-mounted device of claim 1 wherein said strap is of a length to encircle the upper portion of a user's forearm just below the elbow.
